(19) United States
(12) Patent Application Publication
(10) Pub. No.: US 2023/0008236 A1
(43) Pub. Date: Jan. 12, 2023

(54) RIDING SADDLE AND RIDING ACCESSORY

(71) Applicant: GROUPE VOLTAIRE SAS, Bidart (FR)

(72) Inventors: Brice Goguet, Arcangues (FR); Simon Falgaronne, Urt (FR); Mathilde Prevost, Ustaritz (FR)

(73) Assignee: GROUPE VOLTAIRE SAS, Bidart (FR)

(21) Appl. No.: 17/756,900

(22) PCT Filed: Nov. 30, 2020
(86) PCT No.: PCT/EP2020/083954

§ 371 Date: Jun. 3, 2022

(30) Foreign Application Priority Data
Dec. 20, 2019 (FR) FR1915360

(51) Int. Cl. B68C 1/02; B68C 1/14; F16B 1/00

(52) U.S. Cl. CPC B68C 1/02; B68C 1/14; F16B 1/00; F16B 2001/0064

(57) ABSTRACT

The invention relates to a riding saddle intended for being placed on the back of a horse, having at least one main mechanical connecting member, configured to engage with an auxiliary mechanical connecting member of a riding accessory and at least one electronic device. The riding saddle is characterized in that, as the auxiliary mechanical connecting member of the riding accessory comprises at least one auxiliary electrical connector, the main mechanical connecting member has at least one main electrical connector electrically connected to the electronic device by an electrical link, so as to ensure an electrical connection between the main electrical connector of the riding saddle and the auxiliary electrical connector of the riding accessory during the mechanical connection between the main mechanical connecting member of the riding saddle and the auxiliary mechanical connecting member of the riding accessory.

### TECHNICAL FIELD

The present invention relates to the field of riding saddles and especially to a riding saddle equipped with an electronic device connected to an electronic sensor for performing a measurement of a physical parameter of the horse or of a horse riding exercise.

In a known manner, a riding saddle is mounted onto a horse's back and held in position by means of a riding girth extending under the horse's belly. The riding saddle and the riding girth are fastened together by a plurality of belt-like bonds that can be opened and closed manually by a user.

In the horse riding field, it is known to use an electronic sensor to measure the horse's pace or to know its trajectory during a horse race, for example. Some sensors can also be used to measure the horse's physiological data, such as its heart rate, temperature or hygrometry for example.

In the state of the art, such an electronic sensor is known, for example, from document FR3068879A1, which describes a riding girth comprising an electronic module. The electronic module comprises an electronic sensor, for example in the form of an electrode for measuring the heart rate of a moving horse. Such an electrode comprises a one-piece structure in which conductive elements are mounted in the form of pins capable of passing through the animal's coat to capture the measurements directly on its skin. The electronic module further comprises a calculator for analyzing the data measured by the electrode and a battery for powering the electrode and the calculator.

Such an electronic module mounted in the girth has many disadvantages. Indeed, due to the dimensions of the girth, the electronic module comprises a battery with limited autonomy that has to be recharged regularly. Moreover, the electronic module mounted in the girth increases the overall size under the horse, which can hinder the moving horse.

According to the state of the art, from document FR3042185A1, it is also known a riding saddle comprising a saddle tree, defining the structure of the saddle, and an electronic module mounted in the saddle tree. The electronic module comprises an electronic sensor for defining the trajectory of a horse and for determining the impulse of a horse's jump, for example, in front of a fence. The electronic sensor can also allow the measurement of a physiological characteristic of the horse. The electronic module further comprises a microprocessor, for processing the measurements taken by the electronic sensor, and an electric battery for powering the microprocessor and the electronic sensor. However, when measuring physiological data, such as heart rate for example, the electronic sensor mounted in the saddle tree at the pommel of the saddle does not allow an optimal reading since it is far from the animal's heart. The riding saddle described in document FR3042185A1 also comprises a connector, accessible from outside the saddle. The connector allows the electric battery to be recharged or the microprocessor programs to be accessed. Such a connector does not allow mechanical forces to be transmitted to other equipment when the riding hall is in use.

In order to eliminate this drawback, one solution would be to move the electronic sensor to the strap and connect it to the electronic module by a cable or wirelessly. However, a wireless link has the drawback of requiring regular recharging of the electronic sensor since it would no longer be electrically powered. Similarly, a wired link has the drawback of requiring the addition of a further connection cable that is inconvenient and increases the overall size.

The purpose of the invention is to eliminate at least some of these drawbacks by providing a simple reliable electronic system for optimizing the measurement of an animal's physiological data and improving the autonomy of the measurement sensor.

A girth cover is also known from document EP3479690A1, for being mounted onto the riding girth. The girth cover comprises two electrodes for measuring a bioelectric signal, an electronic processing device and two connectors that allow the electrical bonding, in the girth cover, between the electrodes and the processing device. As previously described, the girth cover mounted onto a riding girth significantly increases the overall size under the horse, which may hinder the moving animal. Moreover, because the device is mounted onto the riding girth, the electronic module comprises a battery with limited autonomy that has to be recharged regularly.

Document W02019035420A1 also describes an electronic device for being mounted onto an animal's clothing to measure an electrical signal. The electronic device comprises two electrodes connected to a removable electronic unit via two connectors, the electronic unit being mounted directly onto the clothing. Similar to the previously described device, the electronic device described in document W02019035420A1 significantly increases the overall size, which may hinder the moving animal.

### SUMMARY

The invention relates to a riding saddle for being placed on a horse's back, comprising:
a main structure comprising at least one main mechanical bonding member, configured to cooperate with an auxiliary mechanical bonding member of a riding accessory, and
at least one electronic device, mounted onto the main structure.

The riding saddle is remarkable in that, the auxiliary mechanical bonding member of the riding accessory comprising at least one auxiliary electrical connector, the main mechanical bonding member comprises at least one main electrical connector electrically connected to the electronic device by an electrical bond, so as to ensure an electrical connection between the main electrical connector of the riding saddle and the auxiliary electrical connector of the riding accessory during the mechanical bonding between the main mechanical bonding member of the riding saddle and the auxiliary mechanical bonding member of the riding accessory.

The riding saddle according to the invention advantageously allows an electrical connection to be established with a riding accessory, for example a riding girth, by means of a simple mechanical bonding. Also the electrical connection is simple and quick to implement, since it does not require any additional connection other than the mechanical bonding.

The riding saddle according to the invention advantageously forms a tool holder for any riding accessory. Indeed, by virtue of the invention, whatever riding accessory is suitable for mechanical bond to the riding saddle and which would require an electrical connection, the latter can be electrically connected to the riding saddle. The mechanical bonding between the main mechanical bonding member of the riding saddle and the auxiliary mechanical bonding member of the riding accessory allows mechanical forces to be transmitted between the riding saddle and the riding accessory when a rider performs exercises.

The integration of the electrical connection into the main mechanical bonding member allows the overall size of the riding saddle to be limited by dispensing with the mounting of a particular electrical connector, which would further require the connection of a specific riding accessory that would be specially configured to be connected to the particular connector.

Further, the riding saddle also allows the mechanical bonding of a riding accessory according to prior art, that is, without an auxiliary electrical connector.

According to a preferred embodiment, the main mechanical bonding member is configured to cooperate with the auxiliary mechanical bonding member like a belt bond, advantageously allowing a simple and fast connection of the riding accessory to the riding saddle. Moreover, such a mechanical bonding can easily be made manually by a rider, without requiring the use of a particular tool. By “belt bond” it is meant a bond between a buckle comprising a rod (or tongue), wherein the rod is configured to be inserted into a fastening hole typically formed in a thong.

Preferably, the main mechanical bonding member is a girth strap, advantageously allowing the mechanical bonding with a riding girth that could be equipped with sensors. Thus, an electrical connection could be established between the riding saddle and the riding girth by the simple mechanical bonding of both elements. Such a girth strap advantageously allows the bonding of the riding saddle with a riding girth known in prior art, which advantageously allows the rider not to have to change his/her habits when fastening a riding girth to the riding saddle.

In a preferred embodiment, the electrical bond between the main electrical connector and the electronic device is an electrical ribbon. Such an electrical ribbon allows the addition of a further electrical cable to be dispensed with, which would further require precise positioning of the cable relative to the main electrical connector, thereby increasing complexity and mounting time. In the case of several main electrical connectors, it would be necessary to add several electrical cables, each of which would have to be connected to a main electrical connector independently. An electrical ribbon allows several main electrical connectors to be electrically connected to the electronic device in the same main mechanical bonding member. In other words, the electrical ribbon allows the connection of several main electrical connectors distributed in the main mechanical bonding member.

Furthermore, in the case of a known girth strap comprising two leather plies, the electrical ribbon is advantageously inserted between both leather plies, allowing an invisible mounting, thus advantageously preserving the external aesthetic appearance of the riding saddle.

In one embodiment of the invention, the main electrical connector is in the form of an opening formed in the electrical ribbon, advantageously allowing an electrical connection to be ensured with a riding accessory without requiring the addition of further parts. The electrical connectors can thus be conveniently formed by machining the electrical ribbon. The main electrical connector is also invisible from the outside, thus preserving the aesthetic appearance of the riding saddle. In the case of a girth strap comprising two leather plies between which the electrical ribbon is mounted, the main electrical connector is simple to make. Indeed, the formation of a fastening hole in the leather plies also allows in this case the formation of the opening in the electrical ribbon. Thus, an auxiliary mechanical bonding member can be brought into direct contact with the electrical ribbon as it passes through the fastening hole, and thus the opening forming the main electrical connector, to contact the periphery of the opening.

In another embodiment, the main mechanical bonding member comprising at least one fastening hole comprising an inner diameter, the main electrical connector is configured to extend into the inner diameter of the fastening hole, allowing electrical contact with an auxiliary electrical connector regardless of its positioning in the fastening hole. Further, in the case of a known girth strap comprising two leather plies between which the electrical ribbon is mounted, the electrical ribbon extends partially into the fastening hole. Preferably, the diameter of the opening formed in the ribbon is equal to or less than the diameter of the fastening hole in the plies.

According to one aspect of the invention, the main electrical connector is a metal eyelet, capable of conducting electricity. A metal eyelet allows a simple connection with the auxiliary electrical connector of the riding accessory by means of an element that can be easily integrated on a leather girth strap of a riding saddle. A metal eyelet is also aesthetically pleasing and preserves the external appearance of the saddle. The mounting of a metal eyelet is furthermore simple and quick to carry out, which is advantageous especially when mounting a plurality of main electrical connectors on a plurality of main mechanical bonding members. A metal eyelet also has the advantage of being able to be mounted onto the riding saddle without generating any protrusion or extra thickness. Also, the main electrical connector is mounted onto the riding saddle without hindering the rider.

In one embodiment, the main structure comprising at least two main mechanical bonding members, each of the main mechanical bonding members comprises a main electrical connector electrically connected to the electronic device. The riding saddle then allows the independent connection of several external devices to the same electronic device. Furthermore, this allows, in the case of the connection of a riding girth comprising measurement electrodes for example, that different connection ports of the electronic device are at different electrical potentials, allowing the analysis of a heart rate of the animal for example to be simple and fast.

The invention is also concerned with a riding accessory comprising:
a main body comprising at least one auxiliary mechanical bonding member, configured to cooperate with a main mechanical bonding member of a riding saddle, and
a measurement device, mounted onto the main body.

The riding accessory is remarkable in that the main mechanical bonding member of the riding saddle comprises at least one main electrical connector electrically connected to an electronic device, the auxiliary mechanical bonding member comprises at least one auxiliary electrical connector electrically connected to the measurement device by an auxiliary electrical bond, so as to ensure an electrical connection between the measurement device of the riding accessory and the electronic device of the riding saddle via the auxiliary electrical connector of the riding accessory and the main electrical connector of the riding saddle during the mechanical bonding between the auxiliary mechanical bonding member of the riding accessory and the main mechanical bonding member of the riding saddle.

The riding accessory according to the invention is advantageously electrically connected to the riding saddle to which it is fastened by a simple mechanical bond. Also the riding accessory does not require the local mounting of an electronic device for processing the data transmitted by the measurement device. The processing can be moved in the riding saddle, which advantageously allows the manufacture of a lightweight riding accessory with limited overall size.

Preferably, the riding accessory does not comprise a power source. The measurement device is powered by the auxiliary electrical connector.

In a preferred embodiment, the riding accessory comprises at least one rod, capable of conducting electricity, allowing a simple and fast electrical connection by bringing conductive elements into contact.

According to a preferred embodiment, the auxiliary mechanical bonding member is configured to cooperate with the main mechanical bonding member like a belt bond, advantageously allowing a simple and quick bonding of the riding accessory to the riding saddle. Moreover, such a mechanical bonding can easily be made manually by a rider, without requiring the use of a particular tool.

Alternatively, the auxiliary mechanical bonding member is in the form of a hole formed in the riding accessory, configured to cooperate with a dee or thimble of a riding saddle.

In one embodiment, the riding accessory is in the form of a riding girth, with the main mechanical connecting member being a girth strap, the auxiliary mechanical bonding member is in the form of a strap configured to cooperate with the girth strap of the riding saddle. Such a strap allows the bonding of the riding girth to a riding saddle known in prior art, which advantageously allows the rider not to have to change his/her habits when fastening a riding girth to the riding saddle.

In one embodiment, the main body comprises at least two auxiliary mechanical bonding members, each auxiliary mechanical bonding member comprising at least one auxiliary electrical connector, so as to allow several simultaneous electrical connections.

In one embodiment, the riding accessory comprising at least two measurement devices, each measurement device is respectively electrically connected to an auxiliary electrical connector of a separate auxiliary mechanical bonding member, allowing the simultaneous measurement of several physiological parameters related to the horse. Such an embodiment also advantageously allows the measurement of a heart rate of a horse by allowing the measurement of a potential difference between two electrodes separately connected via two auxiliary electrical connectors.

In one embodiment, the measurement device is electrically connected simultaneously to the auxiliary electrical connector of both auxiliary mechanical bonding members, advantageously allowing, when mounting an active sensor for example, both the transfer of electrical data via a first auxiliary electrical connector and the power supply via a second auxiliary electrical connector.

In one embodiment, the riding accessory, comprises at least:
three auxiliary mechanical bonding members,
three auxiliary electrical connectors, each auxiliary electrical connector being respectively mounted in a separate auxiliary mechanical bonding member, and
three measurement devices, each measurement device is respectively electrically connected to a separate auxiliary electrical connector.

Such an exemplary embodiment advantageously allows both the measurement of a heart rate and the measurement of another physiological parameter of the animal such as its temperature for example.

Such an embodiment also allows the integration of a ground electrode and two measurement electrodes on the riding accessory, so as to perform a reliable measurement of the potential difference between both measurement electrodes.

In one embodiment of the invention, the riding accessory is a riding girth, allowing electrical connection of one or more sensors mounted in the riding girth to the riding saddle.

Alternatively, the riding accessory is a breastplate, martingale, stirrup leather, blanket, saddle pad, snaffle or snaffle bridle.

The invention also relates to an assembly of a riding saddle and at least one riding accessory as previously described, the auxiliary mechanical bonding member of the riding accessory cooperating with the main mechanical bonding member of the riding saddle, so as to electrically connect the main electrical connector and the auxiliary electrical connector by mechanically bonding the main mechanical bonding member of the riding saddle and the auxiliary mechanical bonding member of the riding accessory.

The combination of a riding saddle according to the invention and a riding accessory according to the invention has all the advantages previously described.

In one embodiment, the riding accessory is configured to be connected to the riding saddle in a plurality of different positions, allowing the assembly to be adapted to the animal on which the riding saddle is mounted. Furthermore, regardless of the fastening hole to which the riding accessory is mechanically connected, an electrical connection is established between the riding saddle and the riding accessory.

The invention also relates to an assembly of a riding saddle as previously described and a plurality of riding accessories as previously described, each riding accessory being connected to a main mechanical bonding member, allowing simultaneously both the mechanical bonding and the electrical connection of several riding accessories.

Finally, the invention relates to a method for joining a riding saddle and a riding accessory as described above, the method comprises:
a step of mechanically bonding the main mechanical bonding member of the riding saddle and the auxiliary mechanical bonding member of the riding accessory, and concomitantly
a step of electrically connecting the main electrical connector of the main mechanical bonding member of the riding saddle and the auxiliary electrical connector of the auxiliary mechanical bonding member of the riding accessory so as to electrically connect the electronic device of the riding saddle and the measurement device of the riding accessory.

### BRIEF DESCRIPTION OF THE DRAWINGS

The invention will be better understood upon reading the following description, given only by way of example, and referring to the appended drawings given by way of non-limiting examples, in which identical references are given to similar objects and in which:

FIG. 1 is a schematic representation of a horse onto which a riding saddle and a riding girth are mounted, according to one embodiment of the invention.

FIG. 2 is a schematic representation of an assembly of a riding saddle and a riding girth according to one embodiment of the invention.

FIG. 3 is a schematic representation of an inner structure of the riding saddle of FIG. 2.

FIG. 4 is a detail view of an electronic device and two main mechanical bonding members of the riding saddle of FIG. 2.

FIG. 5A, FIG. 5B and FIG. 5C are close-up front views, along a section plane A:A and along a section plane B:B of a main mechanical bonding member of the riding saddle of FIG. 2 comprising a plurality of main electrical connectors.

FIG. 6 is a front schematic representation of the riding girth of FIG. 2;

FIG. 7 is a rear schematic representation of the riding girth of FIG. 2.

FIG. 8A and FIG. 8B are schematic representations of a mechanical bonding and an electrical connection between the riding saddle and the riding girth of FIG. 2 in the disconnection position and the connection position.

FIG. 9 is a schematic representation of a riding girth according to an alternative embodiment of the invention.

FIG. 10 is a schematic representation of the steps of a method for joining a riding girth to a riding saddle according to the invention.

It should be noted that the figures set out the invention in detail for implementing the invention, said figures may of course be used to better define the invention if necessary.

### DETAILED DESCRIPTION

A riding saddle and a riding accessory according to the invention for being positioned on a horse will be set forth, the riding accessory being for cooperating with the riding saddle. However, it goes without saying that the riding saddle and the riding accessory could just as well be for being positioned on another animal, in particular on any animal that can be ridden by a human, such as a pony or a donkey for example. More specifically, a riding saddle and a riding girth according to one embodiment of the invention will be set forth.

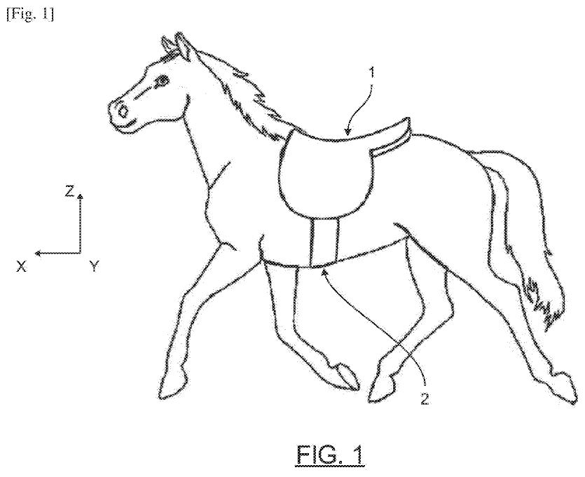

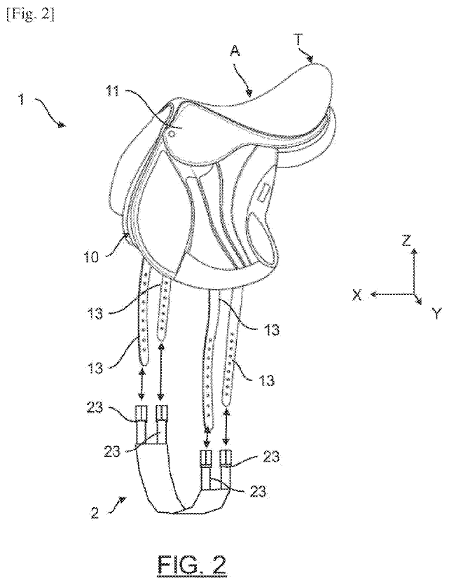

In this example, with reference to FIGS. 1 and 2, the riding saddle 1 and the riding girth 2 are described in an orthogonal reference frame (X, Y, Z) defined with respect to a horse. In the reference frame (X, Y, Z), the riding saddle 1 extends longitudinally along an axis X, transversely along an axis Y and vertically along an axis Z. Also, the terms “bottom” and “top” refer to the axis Z that extends vertically from bottom to top. Similarly, the terms “front” and “rear” refer to the axis X that extends horizontally from the rear to the front of the horse. The terms “left” and “right” refer to the axis Y that extends horizontally from the left to the right, in a front view, that is, a view positioned in the longitudinal axis of the horse.

As represented in FIG. 1, the riding saddle 1 is positioned on a horse's back in order to accommodate a rider. As such, with reference to FIG. 2, the riding saddle 1 comprises a seat A, on which the rider sits and a cantle T, positioned at the rear of the seat A.

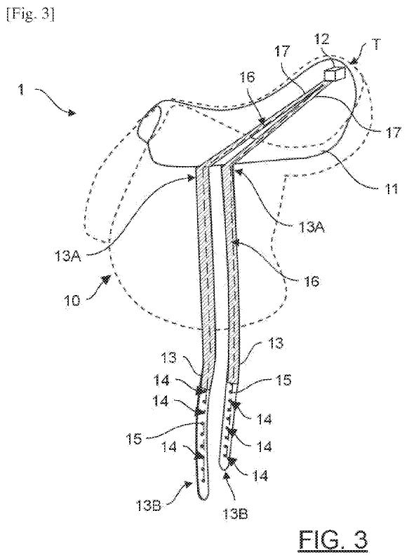

With reference to FIGS. 2 and 3, the riding saddle 1 comprises a main structure 11, in this example in the form of a saddle tree. The main structure 11 is configured to transmit forces during a horse riding activity. The saddle tree is configured to shape the riding saddle 1 by fitting closely the curves of the horse and as such forms the structure of the seat A and the cantle

T. Such a saddle tree is known per se to the person skilled in the art and will not be described further in this document.

The main structure 11 is covered by a covering 10 (represented in dotted line on FIG. 3). The covering 10 comprises an assembly of padding and fabric, such as leather, to ensure the comfort of the riding saddle 1 for the horse and rider.

In this example, with reference to FIG. 2, the main structure 11 comprises four main mechanical bonding members 13, two main mechanical bonding members 13 on each side of the riding saddle 1. Each main mechanical bonding member 13 is configured to cooperate with an auxiliary mechanical bonding member 23 of the riding girth 2 assembled to the riding saddle 1 as will be described in more detail later.

In a preferred embodiment, represented in FIG. 3, each main mechanical bonding member 13 is in the form of a girth strap comprising a first end 13A fixedly connected to the main structure 11 and a free opposite second end 13B. The second end 13B comprises a plurality of fastening holes 14, advantageously allowing adjustment of the positioning of the riding girth 2. Each fastening hole 14 comprises an inner diameter, for cooperating with an auxiliary mechanical bonding member 23 of the riding girth 2, for the purpose of fastening the latter to the riding saddle 1. In one exemplary embodiment of the invention, the fastening hole 14 is configured to cooperate with a tongue of a buckle, like a buckle/hole belt bond, as will be described in more detail later in this document.

This document describes an example of a main mechanical bonding member 13 in the form of a girth strap. However, it goes without saying that each main mechanical bonding member 13 may be in a variety of forms, the important thing being that the main mechanical bonding member 13 forms an attachment point for fastening a riding accessory. By way of example, the main mechanical bonding member 13 may be in the form of a stirrup leather support, a saddle nail or even a fastening lug, for example, for cooperating with an opening in a thong. The main mechanical bonding member 13 could also be in the form of a dee or thimble for a riding saddle 1 for fastening draw reins or luggage. In a known manner, a thimble or dee is in the form of a hinged buckle. In other words, the main mechanical bonding member 13 could be in the form of a buckle configured to cooperate with, for example, a thong inserted into the buckle and folded back on itself.

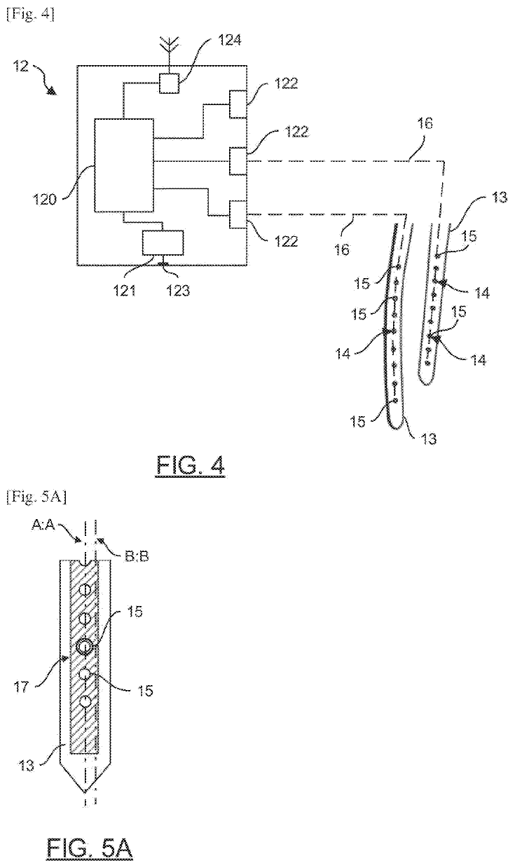

With reference to FIGS. 3 and 4, the riding saddle 1 according to the invention comprises an electronic device 12 mounted in the main structure 11, however it goes without saying that it could be mounted in the covering 10. In this example, the electronic device 12 is mounted onto the main structure 11 at the cantle T, as represented in FIG. 3, allowing the electronic device 12 to be placed in a zone in which the overall size is less significant.

In this example, with reference to FIG. 4, the electronic device 12 comprises an on-board calculator 120, configured to process a plurality of data, a power supply device 121 for guaranteeing the autonomy of the electronic device 12 and especially of the on-board calculator 120, and a plurality of connection ports 122, configured to receive electrical signals from an external device and connected to the on-board calculator 120.

As represented in FIG. 4, the electronic device 12 also comprises a recharging port 123, for example of the USB type, electrically connected to the power supply device 121 and configured to allow electrical recharging, in particular, by connection to an electrical outlet or to an outer power supply device. The electronic device 12 further comprises a wireless communication device 124 capable of exchanging data with an outer communication device, for example a smartphone, via a telecommunication network, for example of the 4G or Bluetooth® type.

In one embodiment, the electronic device 12 is removable, so as to allow, for example, its recharging without requiring the immobilization of the riding saddle 1. Moreover, in case of a defective electronic device 12, for example, it is thus simple and fast to replace.

With reference to FIG. 4, each main mechanical bonding member 13 comprises a plurality of main electrical connectors 15, configured to conduct electricity.

In this example, one main electrical connector 15 is configured to be positioned at each fastening hole 14.

Each main electrical connector 15 is made of a conductive material, so as to conduct electricity. By way of example, each main electrical connector 15 is made of a metal material, a material loaded with conductive elements (for example, carbon), or a fabric incorporating lead wires.

As represented in FIG. 4, each main electrical connector 15 is electrically connected to the electronic device 12, via a connection port 122, by an electrical bond 16, so as to electrically connect the electronic device 12 and each main electrical connector 15. In this example, regardless of the fastening hole 14 through which the auxiliary mechanical bonding member 23 of the riding girth 2 is connected to the main mechanical bonding member 13, an electrical connection is established, as will be described in more detail later.

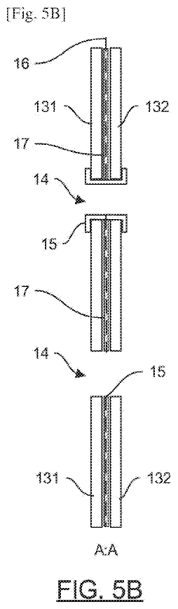

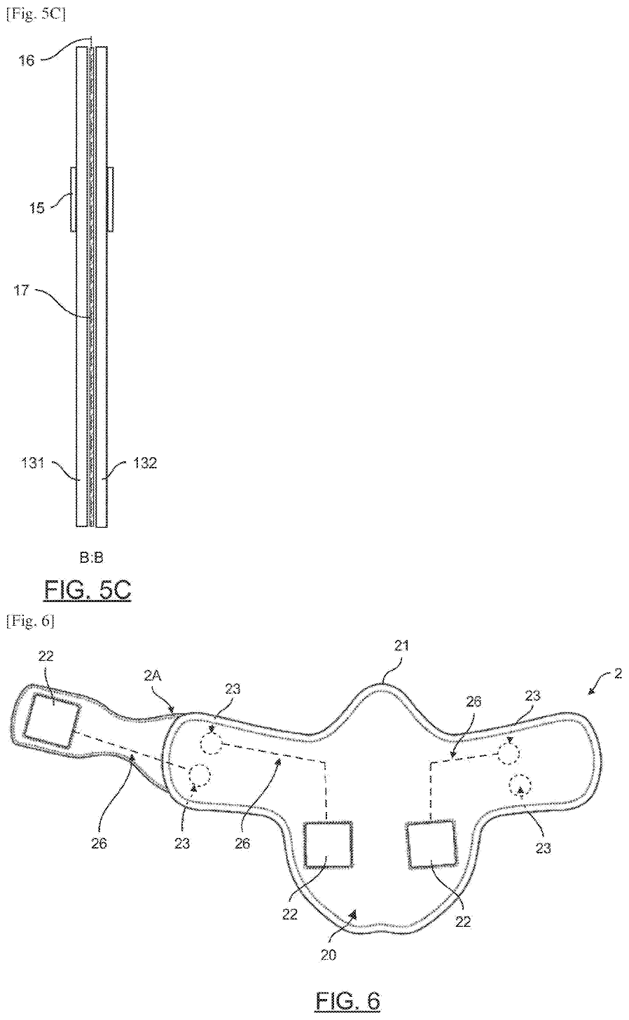

According to a preferred embodiment, represented in FIGS. 3 and 5A, the electrical bond 16 is in the form of an electrical ribbon 17.

Preferably, with reference to FIGS. 5A, 5B and 5C, each main mechanical bonding member 13, in other words each girth strap of the riding saddle 1, comprises two plies 131, 132, preferably made of leather. As represented in FIGS. 5B and 5C, representing two cross-section views of a main mechanical bonding member 13, both plies 131, 132 are positioned opposite each other and configured to be sewn together to form a closed envelope. The electrical ribbon 17 is positioned between both plies 131, 132, in order to connect the main electrical connectors 15 to the electronic device 12. The electrical ribbon 17 is then invisible from the outside of the girth straps so as to preserve the external appearance of the riding saddle 1.

In this embodiment, each main electrical connector 15 is in the form of an opening formed in the electrical ribbon 17 at one of the fastening holes 14, as represented in FIGS. 5A and 5B. The main electrical connector 15 is thus invisible from the outside, thus preserving the aesthetic appearance of the riding saddle 1. Moreover, in the case of a girth strap comprising two leather plies between which the electrical ribbon 17 is mounted, each main electrical connector 15 is simple to make. Indeed, the formation of a fastening hole 14 in the plies 131, 132 simultaneously allows the formation of the opening in the electrical ribbon 17. Furthermore, the risks of disconnection are limited. Preferably, the main mechanical bonding member 13 comprises a reinforcement thong, in particular of nylon, positioned between the plies 131, 132.

The use of an electrical ribbon 17 has the advantage of being able to insert the electrical bond 16 between the plies 131, 132 of each main mechanical bonding member 13 while allowing all the main electrical connectors 15 of the same main mechanical bonding member 13 to be electrically connected to the connection port 122 of the electronic device 12. In other words, the electrical ribbon 17 allows the addition of further independent electrical cables to be dispensed with, which would further require precise positioning of each of the electrical cables in the girth strap to connect each main electrical connector 15 independently to the electronic device 12. An electrical ribbon 17 promotes the bonding of main electrical connectors 15 that are distributed. In this example, each main mechanical bonding member 13 is connected to a different connection port 122 so as to allow the electronic device 12 to connect to four measurement devices 22, as will be described in more detail later. In other words, each electrical bond 16 allows the exchange of a separate electrical signal between one of the measurement devices 22 and one of the connection ports 122 of the electronic device 12.

Preferably, the main electrical connector 15 extends into the inner diameter of each fastening hole 14. Preferably, the diameter of the main electrical connector 15 is less than or equal to the diameter of the fastening hole 14.

In an alternative embodiment, the main electrical connector 15 is configured to be fastened to one of the fastening holes 14 so as to cover the inner diameter of each fastening hole 14. In particular, each main electrical connector 15 is in the form of an eyelet, configured to be inserted into a fastening hole 14, so as to cover the inner edges of the inner diameter of the fastening hole 14.

A main mechanical bonding member 13 of the girth strap type is set forth, comprising two leather plies between which an electrical ribbon 17 is inserted, however it goes without saying that the main mechanical bonding member 13 could be in a different form. According to a preferred aspect, the reinforcement thong could in this case comprise one or more conductive fibers, for example a metal wire, capable of conducting electricity. In this case, each fastening hole 14 could be formed directly in the reinforcement thong. In other words, the reinforcement thong incorporates the electrical bond 16.

Similarly, a riding saddle 1 is set forth, comprising four main mechanical bonding members 13 each comprising a plurality of fastening holes 14, however, it goes without saying that the invention also applies to a riding saddle 1 comprising a different number of main mechanical bonding members 13, especially two main mechanical bonding members 13 or a single main mechanical bonding member 13. Similarly, each main mechanical bonding member 13 could just as easily comprise a single fastening hole 14 and a single main electrical connector 15.

A method for manufacturing a riding saddle 1 as previously described will now be described.

The manufacturing method comprises a first step of fastening the electronic device 12 to the main structure 11 of the riding saddle 1. Preferably, in this step, the operator fastens the electronic device 12 to the saddle tree at the cantle T.

The operator then fastens an electrical ribbon 17 between both plies 131, 132 of each main mechanical bonding member 13 along the entire length of the main mechanical bonding member 13, that is from the fixed end 13A to the tip of the free end 13B. A reinforcement thong (not represented) may also be added. Each main mechanical bonding member 13 is fastened to the main structure 11. For each main mechanical bonding member 13, an electrical ribbon 17 is then connected to the electronic device 12, thus each main electrical connector 15 of each main mechanical bonding member 13 is electrically connected to the electronic device 12.

Finally, the operator makes a main electrical connector 15 on each fastening hole 14 of each main mechanical bonding member 13. In this example, the operator simultaneously punctures the leather plies 131, 132 and the electrical ribbon 17 mounted between both plies 131, 132 so as to simultaneously form the fastening hole 14 and the opening in the electrical ribbon 17 forming the main electrical connector 15.

A riding accessory in the form of a riding girth 2 is set forth herein. The riding girth 2 is configured to extend under the horse's belly and to cooperate with the riding saddle 1 on either side of the main structure 11, so as to fasten the riding saddle 1 to the horse's back.

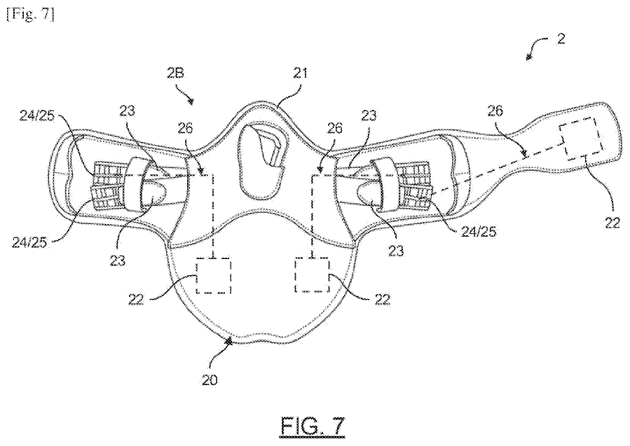

With reference to FIGS. 6 and 7, the riding girth 2 comprises a front face 2A (FIG. 6), for being brought into contact with the horse, and a rear face 2B (FIG. 7), opposite to the front face 2A. In this example, the front face 2A of the riding girth 2 is for being mounted under the horse and being brought into contact with the horse's belly, that is, opposite to the riding saddle 1 mounted onto the horse's back.

The riding girth 2 according to the invention comprises a main body 21 covered by a covering 20. The covering 20 comprises an assembly of padding and fabric, for example leather, to provide comfort for the horse.

In this example, with reference to FIG. 7, the main structure 21 comprises four auxiliary mechanical bonding members 23, two auxiliary mechanical bonding members 23 on each side of the riding girth 2, so as to allow the riding girth 2 to be fastened on either side of the riding saddle 1. Each auxiliary mechanical bonding member 23 is configured to cooperate with a separate main mechanical bonding member 13 of the riding saddle 1.

In a preferred embodiment, each auxiliary mechanical bonding member 23 is in the form of a strap for cooperating with one of the girth straps of the riding saddle 1 previously described. As such, each auxiliary mechanical bonding member 23 comprises a buckle, of the belt buckle type, comprising a rod 24, configured to cooperate with the plurality of fastening holes 14 of one of the main mechanical bonding members 13. In other words, the rod 24 is similar to the tongue of a belt buckle, configured to be inserted into a hole of a thong so as to secure two elements. Such a cooperation allows each auxiliary mechanical bonding member 23 to be connected to a main mechanical bonding member 13, allowing the riding girth 2 to be fastened to the riding saddle 1. Such a mechanical cooperation is known per se and is similar to prior art, which is advantageous for riders whose habits are not changed.

This document sets forth an example of an auxiliary mechanical bonding member 23 in the form of a buckle. However, it goes without saying that the auxiliary mechanical bonding member 23 may be in any form capable of mechanically connecting a riding saddle 1. By way of example, the auxiliary mechanical bonding member 23 may be in the form of a leather thong forming a loop for being inserted into a thimble or dee of a riding saddle 1. In this case, the leather loop comprises a ply made of a conductive material positioned inside the loop and for being brought into contact with the thimble or dee of the riding saddle 1. The auxiliary mechanical bonding member 23 could also be in the form of a collar button for being inserted into a hole of a leather thong comprising, for example, an electrical ribbon or a border made of a conductive material, or of a snap button, capable of conducting electricity between the male and female parts of a known snap button. According to other exemplary embodiments, the auxiliary mechanical bonding member 23 could also be in the form of a metal snap hook or a cord comprising wires of a conductive material, for example.

In a preferred embodiment of the invention, with reference to FIGS. 6 and 7, the riding girth 2 comprises three measurement devices 22, mounted onto the main body 21 and preferably distributed over the entire riding girth 2. Such positioning allows the measurement points to be distributed so as to limit the interferences between different closely spaced points. Each measurement device 22 is preferably mounted onto the front side 2A of the main body 21, so that it can be brought into contact with the skin of the animal, when the riding girth 2 is mounted onto the horse.

In this example, each measurement device 22 is in the form of a sensor capable of measuring a physiological data of the horse. Each measurement device 22 is preferably passive and is, for example, in the form of an electrode capable of measuring an electrical potential for measuring a heart rate of the horse. By passive sensor, it is meant a sensor that does not require an electrical power supply. Such a sensor can alternatively measure the temperature of the horse or its hygrometry for example. Similarly, each measurement device 22 may also be in the form of an active sensor capable of measuring, for example, kinematics or speed of movement of the horse.

In the example of the measurement of a heart rate of the horse, two electrodes are for example connected to two separate auxiliary mechanical bonding members 23 and spaced apart on the main body 21 so as to allow a reliable measurement. A third electrode is preferably connected simultaneously to both auxiliary mechanical bonding members 23 and forms a ground electrode, for forming a reference for measuring the electrical potentials from the first two electrodes.

A riding girth 2 is set forth, comprising three measurement devices 22 so as to enable the recording of an electrocardiogram of the horse, however it goes without saying that the riding girth 2 could just as well comprise a different number of measurement devices 22, for example two measurement devices 22 or a single measurement device 22. Similarly it goes without saying that the riding girth 2 could comprise, for example, two passive measurement devices 22 and one active measurement device 22.

With reference to FIG. 7, each auxiliary mechanical bonding member 23 comprises an auxiliary electrical connector 25, configured to conduct electricity. Each auxiliary electrical connector 25 is made of a conductive material, for example a metal material, so as to conduct electricity without requiring the addition of a further conductive part.

In a preferred embodiment, the auxiliary electrical connector 25 corresponds to the rod 24 of the auxiliary mechanical bonding member 23 previously described.

As represented in FIGS. 6 and 7, each auxiliary electrical connector 25 is electrically connected to one of the measurement devices 22 by an auxiliary electrical bond 26. Each auxiliary electrical connector 25 is connected to a separate measurement device 22 by a separate auxiliary electrical bond 26. In other words, each measurement device 22 is electrically connected to a separate auxiliary mechanical bonding member 23.

According to a preferred embodiment, each auxiliary electrical bond 26 is in the form of an electrical cable mounted in the covering 20 of the riding girth 2. Such a positioning advantageously makes it possible to limit the risks of catching a floating electrical cable that could be torn off or could hinder the horse and/or the rider. Alternatively, the auxiliary electrical bond 26 could also be in the form of an electrical ribbon.

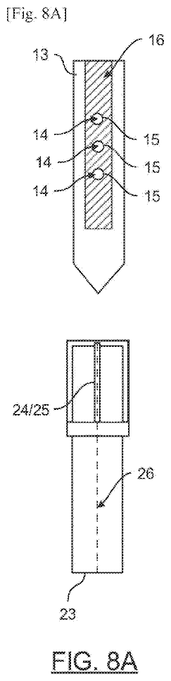

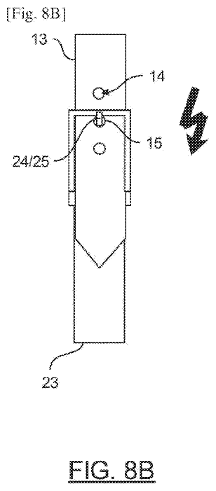

An assembly of a riding saddle 1 and a riding girth 2 as previously described will now be described with reference to FIGS. 2, 8A and 8B.

In this example, as represented in FIG. 2, the riding saddle 1 comprises four main mechanical bonding members 13 and the riding girth 2 comprises four auxiliary mechanical bonding members 23. The riding girth 2 further comprises three measurement devices 22, each measurement device 22 being electrically connected to an auxiliary electrical connector 25 independent of an auxiliary mechanical bonding member 23.

As previously described and represented in FIG. 2, each auxiliary mechanical bonding member 23 of the riding girth 2 is in the form of a strap, configured to be mechanically connected to one of the main mechanical bonding members 13 of the riding saddle 1, each of which is in the form of a girth strap.

Upon fastening the riding girth 2 to the riding saddle 1, each main mechanical bonding member 13, that is, each girth strap, is inserted into the buckle of one of the auxiliary mechanical bonding members 23, that is, into the buckle of one of the straps. As represented in FIG. 8A, the rod 24 of the metal buckle of the strap is inserted into one of the fastening holes 14 of the opposite girth strap, so as to allow the mechanical fastening of the riding girth 2 to the riding saddle 1. Each of the four straps is thus respectively inserted into one of the fastening holes 14 of the girth strap of the riding saddle 1 positioned opposite (as represented in FIG. 2) so as to fasten the riding girth 2 on either side of the riding saddle 1.

In other words, the riding girth 2 is fastened to the riding saddle 1 by means of four rod /hole belt type bonds, with the plurality of fastening holes 14 in each girth strap allowing the tightening of the riding girth 2 around the horse's belly to be adjusted. Such a riding girth 2 is advantageously conventional for a rider.

As represented in FIG. 8B, the mechanical fastening of the riding girth 2 to the riding saddle 1 allows for each bonding of a strap with a girth strap, the contacting of a main electrical connector 15 and an auxiliary electrical connector 25, advantageously allowing the electrical connection of the main mechanical bonding member 13 and the auxiliary mechanical bonding member 23. Advantageously, regardless of the fastening hole 14 of the main mechanical bonding member 13 to which the auxiliary mechanical bonding member 23 is mechanically connected, an electrical connection is ensured.

In other words, the mechanical fastening of the riding girth 2 to the riding saddle 1 allows the exchange of electrical information between each measurement device 22 of the riding girth 2 and the electronic device 12 of the riding saddle 1. In this example, since each connection port 122 of the electronic device 12 is connected to a separate main electrical connector 15, each is at the same electrical potential as the measurement device 22 to which it is connected.

The mechanical bonding of the riding girth 2 and the riding saddle 1 according to the invention thus advantageously allows the simultaneous establishment of an electrical connection between the riding saddle 1 and the riding girth 2. Such an electrical connection advantageously allows the on-board calculator 122 in the riding saddle 1 to receive and process the data measured by each measurement device 22 mounted in the riding girth 2. Also, the riding girth 2 can dispense with the local mounting of an on-board calculator and a power supply battery that could increase the overall size and hinder the moving horse for example.

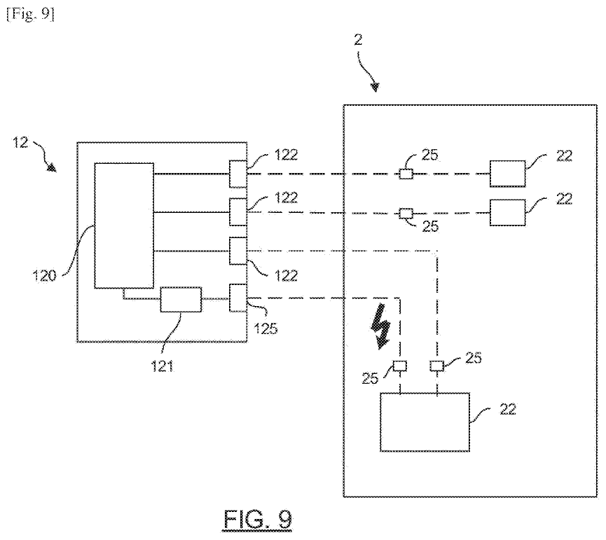

In one embodiment of the invention represented in FIG. 9, the riding girth 2 comprises three measurement devices 22, two passive sensors, to allow measurement of a heart rate of the horse for example, and one active sensor, to allow measurement of a kinematics of the horse for example. Since the riding girth 2 comprises four auxiliary mechanical bonding members 23 each comprising an auxiliary electrical connector 25, both passive measurement devices 22 are each connected to a separate auxiliary electrical connector 25. The active measurement device 22 is simultaneously connected to the other two auxiliary electrical connectors 25, so as to allow both the transfer of electrical data via one of the connection ports 122 of the electronic device 12 and the power supply of the third measurement device 22, via a power supply port 125 to the power supply device 121.

The electrical connection between the riding girth 2 and the riding saddle 1 advantageously allows in this embodiment the measurement device 22 mounted in the riding girth 2 to be electrically powered by means of the power supply device 123 of the riding saddle 1. Such a mounting advantageously allows the autonomy of the measurement device 22 while keeping a lightweight riding girth 2 with a limited overall size. Furthermore, the power supply of each measurement device 22 by a power supply device 123 mounted in the riding saddle 1 ensures a longer autonomy. Indeed, the electronic device 12 mounted in the riding saddle 1 allows the use of a power supply device 123 having a larger volume than if it were mounted in the riding girth 2, allowing the installation of a higher performance power supply device 121. In other words, the autonomy of the measurement device 22 is advantageously greater and the overall size under the horse is greatly limited. From a practical point of view, only the riding saddle 1 needs to be recharged.

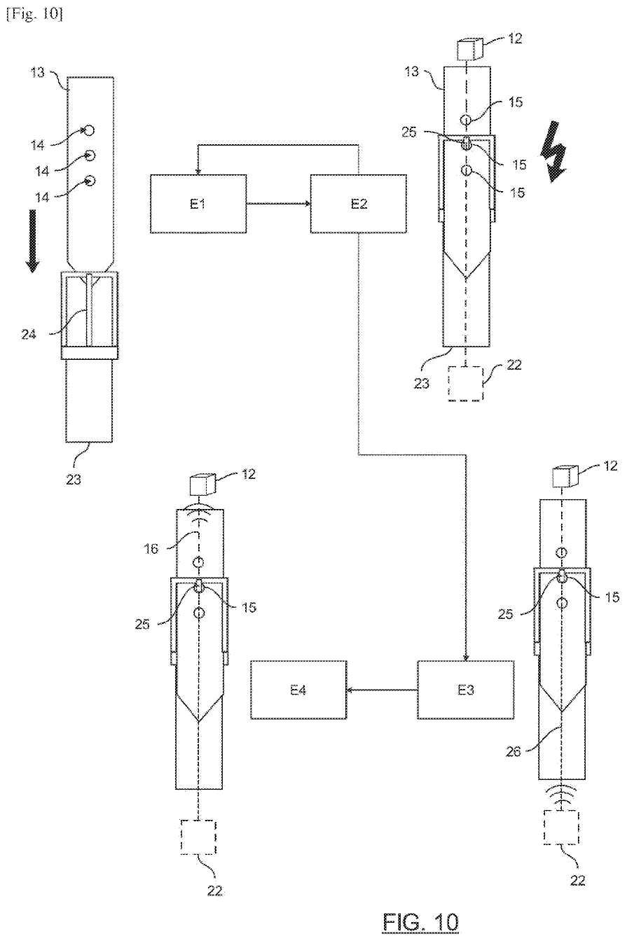

A method for joining a riding saddle 1 and a riding girth 2 as previously described will now be described with reference to FIG. 10. The joining method is described for the example of a riding girth 2, however it goes without saying that the method applies for joining any riding accessory configured to be connected to a riding saddle 1. Moreover, the method is described in this example for a riding saddle 1 mounted onto the horse's back, however it goes without saying that the riding saddle 1 could just as well be placed in a tack room or on any support, for example in order to test the operation of the electronic device 12 or the measurement devices 22.

In this example, the riding saddle 1 comprises four main mechanical bonding members 13 and the riding girth 2 comprises four auxiliary mechanical bonding members 23. The riding girth 2 further comprises three measurement devices 22, each measurement device 22 being electrically connected to an independent auxiliary electrical connector 25.

The method comprises a first step of mechanically bonding E1 a first main mechanical bonding member 13 of the riding saddle 1 and a first auxiliary mechanical bonding member 23 of the riding girth 2. For this purpose, in this example, a first girth strap of the riding saddle 1 is inserted by the user into a first buckle of a strap of the riding girth 2 in order to obtain the desired mechanical tightening. The user inserts the rod 24 of the first buckle into one of the fastening holes 14 of the first girth strap.

The method then comprises a second step of electrically connecting E2 the riding girth 2 and the riding saddle 1 by contacting a main electrical connector 15 of the first main mechanical bonding member 13 and the auxiliary electrical connector 25 of the first auxiliary mechanical bonding member 23. A first measurement device 22 of the riding girth 2 is then electrically connected to the electronic device 12 of the riding saddle 1. The rod 24 is in contact with the periphery of the opening formed in the electrical ribbon 17

The operation is repeated for the second main mechanical bonding member 13, the third main mechanical bonding member 13 and the fourth main mechanical bonding member 13 of the riding saddle 1. The second main mechanical bonding member 13 is mechanically bonded to the second auxiliary mechanical bonding member 23 of the riding girth 2. The second measurement device 22 of the riding girth is then electrically connected to the electronic device 12 of the riding saddle 1 via one of the main electrical connectors 15 of the second main mechanical bonding member 13 and the auxiliary electrical connector 25 of the second auxiliary mechanical bonding member 23. Similarly, the third main mechanical bonding member 13 is connected to the third auxiliary mechanical bonding member 23 and the fourth main mechanical bonding member 13 is connected to the fourth auxiliary mechanical bonding member 23.

In use, the measurement devices 22 measure, in a step E3, data related to the horse such as, for example, its heart rate, temperature or speed. The measured data is then sent, in a step E4, to the on-board calculator 120 of the electronic device 12, via the electrical bonds 16, 26 in order to be processed and subsequently transmitted, via the communication device 124, over a communication network.

Joining the riding girth 2 and the riding saddle 1 according to the invention advantageously makes it possible to simultaneously ensure the mechanical fastening and the electrical connection of both elements.

The example of a riding girth 2 is set forth in this document, however it goes without saying that the invention also applies to any riding accessory configured to be mechanically fastened to a riding saddle 1, such as a breastplate, a martingale or a stirrup leather for example. The riding accessory could also be in the form of a blanket, saddle pad, snaffle or snaffle bridle for example.

Advantageously, the riding saddle 1 forms a tool holder for any accessory, thereby reducing the cost and overall size of the accessories.

Similarly, a riding saddle 1 comprising four main mechanical bonding members 13 each comprising a plurality of fastening holes 14 and a riding girth 2 comprising four auxiliary mechanical bonding members 23 are described, however, it goes without saying that the invention also applies to a riding saddle 1 comprising a different number of main mechanical bonding members 13, especially two main mechanical bonding members 13 or a single main mechanical bonding member 13. Similarly, each main mechanical bonding member 13 could just as easily comprise a single fastening hole 14 and a single main electrical connector 15. Similarly, the riding girth 2 could comprise a different number of auxiliary mechanical bonding members 23, especially two auxiliary mechanical bonding members 23 or a single auxiliary mechanical bonding member 23.

Furthermore, to allow the fastening of a riding accessory to the riding saddle 1, each main mechanical bonding member 13 could alternatively comprise a metal lug fastened to the main structure 11 of the riding saddle 1. In this case, each auxiliary mechanical bonding member 23 could comprise a flange comprising one or more holes configured to cooperate with the lug of the main mechanical bonding member 13. Alternatively, each main mechanical bonding member 13 and each auxiliary mechanical bonding member 23 could also each comprise one of the complementary elements of a snap button. In other words, the bond between the main mechanical bonding member 13 and the auxiliary mechanical bonding member 23 could be in any form that allows a mechanical bonding between the riding saddle 1 and the riding accessory 2.

1-14. (canceled)

15. A riding saddle for being placed on a back of a horse, comprising:
a main structure comprising at least one main mechanical bonding member, configured to cooperate with an auxiliary mechanical bonding member of a riding accessory, and
at least one electronic device, mounted onto the main structure,
the riding saddle wherein, the auxiliary mechanical bonding member of the riding accessory comprising at least one auxiliary electrical connector, the main mechanical bonding member comprises at least one main electrical connector electrically connected to the at least one electronic device by an electrical bond so as to ensure an electrical connection between the main electrical connector of the riding saddle and the auxiliary electrical connector of the riding accessory during the mechanical bonding between the main mechanical bonding member of the riding saddle and the auxiliary mechanical bonding member of the riding accessory.

16. The riding saddle according to claim 15, wherein the main mechanical bonding member is configured to cooperate with the auxiliary mechanical bonding member like a belt connection.

17. The riding saddle according to claim 15, wherein the main mechanical bonding member is a girth strap.

18. The riding saddle according to claim 15, wherein the electrical bond between the main electrical connector and the electronic device is an electrical ribbon.

19. The riding saddle according to claim 18, wherein the main electrical connector is in the form of an opening formed in the electrical ribbon.

20. The riding saddle according to claim 15, wherein the main structure comprising at least two main mechanical bonding members, each of the main mechanical bonding members comprises a main electrical connector electrically connected to the electronic device.

21. A riding accessory comprising:
a main body comprising at least one auxiliary mechanical bonding member, configured to cooperate with a main mechanical bonding member of a riding saddle, and
a measurement device, mounted onto the main body,
the riding accessory wherein, the main mechanical bonding member of the riding saddle comprising at least one main electrical connector electrically connected to an electronic device, the auxiliary mechanical bonding member comprises at least one auxiliary electrical connector electrically connected to the measurement device by means of an auxiliary electrical bond so as to ensure an electrical connection between the measurement device of the riding accessory and the electronic device of the riding saddle via the auxiliary electrical connector of the riding accessory and the main electrical connector of the riding saddle during the mechanical bonding between the auxiliary mechanical bonding member of the riding accessory and the main mechanical bonding member of the riding saddle.

22. The riding accessory according to claim 21, comprising at least one rod configured to conduct electricity.

23. The riding accessory according to claim 21, wherein the main body comprises at least two auxiliary mechanical bonding members, each auxiliary mechanical bonding member comprising at least one auxiliary electrical connector.

24. The riding accessory according to claim 23, comprising at least two measurement devices, each measurement device is respectively electrically connected to an auxiliary electrical connector of a separate auxiliary mechanical bonding member.

25. The riding accessory according to claim 24, wherein the measurement device is electrically connected simultaneously to the auxiliary electrical connector of both auxiliary mechanical bonding members.

26. The riding accessory according to claim 21, wherein the riding accessory is a riding girth.

27. An assembly comprising:
a riding saddle for being placed on a back of a horse and of a riding accessory, the riding saddle comprising a main structure comprising at least one main mechanical bonding member, at least one electronic device, mounted onto the main structure, the main mechanical bonding member comprising at least one main electrical connector electrically connected to the at least one electronic device by an electrical bond, the riding accessory comprising:
a main body comprising at least one auxiliary mechanical bonding member, configured to cooperate with the main mechanical bonding member of the riding saddle, and
a measurement device, mounted onto the main body,
the auxiliary mechanical bonding member comprising at least one auxiliary electrical connector electrically connected to the measurement device by means of an auxiliary electrical bond so as to ensure an electrical connection between the measurement device of the riding accessory and the electronic device of the riding saddle via the auxiliary electrical connector of the riding accessory and the main electrical connector of the riding saddle during the mechanical bonding between the auxiliary mechanical bonding member of the riding accessory and the main mechanical bonding member of the riding saddle.

28. A method for joining a riding saddle and a riding accessory according to an assembly according to claim 27, the method comprises:
a step of mechanically bonding the main mechanical bonding member of the riding saddle and the auxiliary mechanical bonding member of the riding accessory, and concomitantly
a step of electrically connecting the main electrical connector of the main mechanical bonding member of the riding saddle and the auxiliary electrical connector of the auxiliary mechanical bonding member of the riding accessory so as to electrically connect the electronic device of the riding saddle and the measurement device of the riding accessory.
